(19) United States
(12) Patent Application Publication
(10) Pub. No.: US 2004/0211068 A1
(43) Pub. Date: Oct. 28, 2004

(54) Reversible scissors

(76) Inventors: Salman Yusufov, Brooklyn, NY (US); Nazim Yusufov, Brooklyn, NY (US)

Correspondence Address: Salman Yusufov, 1439 Ocean Ave. # 5D, Brooklyn, NY, 11230, US

(21) Appl. No.: 10/419,628

(22) Filed: Apr. 21, 2003

(51) Int. Cl. B26B 13/00

(52) U.S. Cl. 30/232; 30/341; 30/254

(57) ABSTRACT

A reversible scissors comprising a pair of pivotally connected two edge cutting blade members, operating handles and ring members. Ring members are connected pivotally with and movably along the operating handles.

### BACKGROUND OF THE INVENTION

The present invention relates to a reversible instruments, and more particularly to an improved reversible scissors and shears having pair of two edge cutting blades.

Such reversible scissors are known in the art and described, for example, in U.S. Pat. No. 300,153. This invention relates to the scissors and shears; and it is has for its object to provide the same with reversible handles, whereby both edges of the scissors or shears may be sharpened and employed for cutting purposes by reversing the position of one of the handles around a horizontal axis.

However, this construction of instruments have limitation for usage a reversible scissors having crane position of handles (or rings) concerning the cutting blades which may change-over to opposing and offset. More over, this construction cannot be use for reversible scissors which have small sizes, for example, cuticle scissors.

### SUMMARY OF THE INVENTION

Accordingly, it is one object of the present invention to provide a reversible scissors which avoids the disadvantages of the prior art.

In keeping with this object and with others which will become apparent hereinafter one feature of the present invention resides, briefly stated in a reversible scissors having a pair of two edge cutting blade members with operating handles and ring members of improved construction, which can be reversed for both of following reasons;-to provide another and sharp cutting edges and/or to be readily adapted to right as well as left handed persons.

The improvement also consists of the novel feature, details of construction, and combination of parts the reversible scissors which may have change-over position of ring members to opposing, offset and crane concerning the cutting blade members and handles.

The novel feature of the present invention will be defined in the claims.

The invention itself, however, will be best understood from the following description which are accompanied by the drawings.

### BRIEF DESCRIPTION OF THE DRAWINGS

FIGS. 1, 8, 12, 14 are longitudinal views of the reversible scissors in accordance with the present invention;

FIGS. 2, 9, 13, 15 are vertical views of FIGS. 1, 8, 12, 14;

FIG. 3 is a fragmentary cross-sectional view on the line 3-3 of FIG. 2 on an enlarged scale;

FIG. 4 is a vertical view illustrating the scissors in open position;

FIGS. 5, 11, 16 are vertical views of the reversed scissors for utilize other pair of cutting edges, or adjusted for left handed persons;

FIGS. 6, 17 are views similar to FIGS. 2, 9, 13, 15 and modified form of the invention;

FIG.7 IS a fragmentary cross-sectional view on the line 7-7 of FIG. 6 on an enlarged scale;

FIG. 10 is a longitudinal view of the reversible scissors in the half reversed position, FIGS. 18, 19 are fragmentary cross-sectional views on the line 18-18, 19-19 of FIG. 17 on an enlarged scale;

FIGS. 20 to 23 are fragmentary views of the reversible scissors.

### DESCRIPTION OF PREFERED EMBODIMENTS

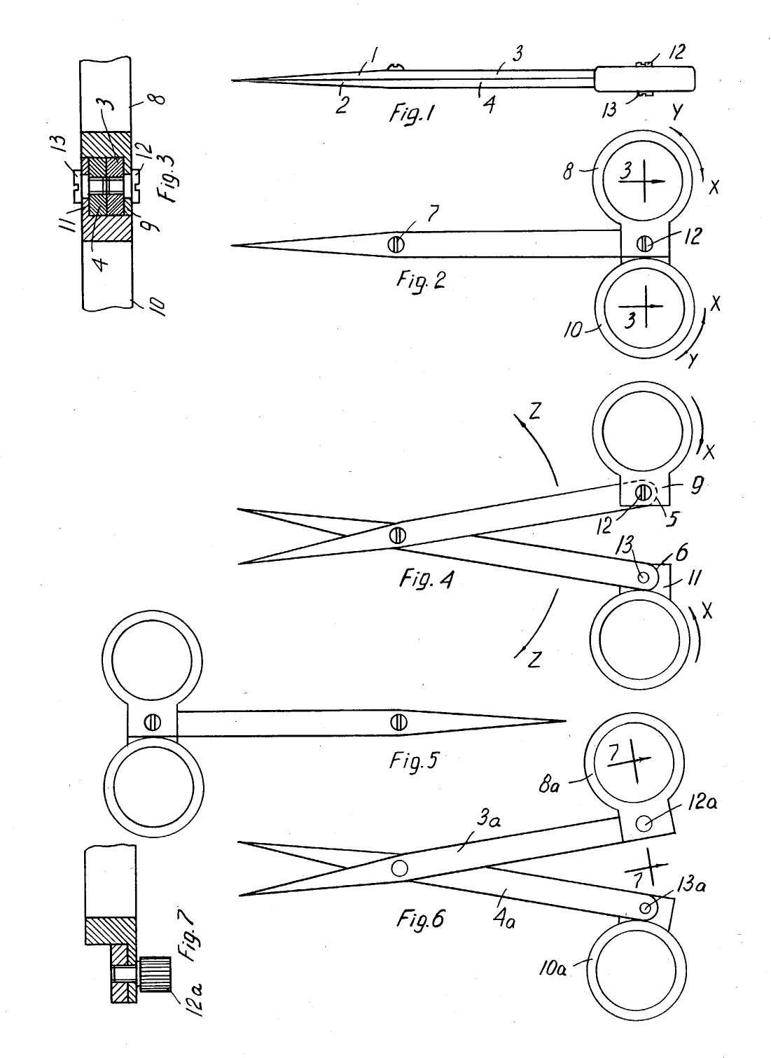

A reversible scissors in accordance with the present invention has a pair of two edge cutting blade members 1, 2 (FIGS. 1 to 4) having operating handles 3, 4 pivotally connected by screw 7, and a pair of ring members 8, 10. Handles 3, 4 have a segmental form heads 5, 6 and ring members with their necks 9, 11 pivotally connected with handles by screws 12, 13 respectively, so that the ring member 8 may turn around a pivot 12 and the ring member 10 may turn around the pivot 13. Cutting blade members are preferably of concavo-convex form, the inner opposing sides or faces being hollow.

When a user opens a scissors ring members 8, 10 turn to the opposite direction X. When the user closes the scissors ring members turns to the opposite direction Y and return at initial position.

In order to reverse the scissors so as to utilize the other pair of cutting edges, operating handles are reversed by 360 degree to the opposite direction Z around the pivot 7, and each ring member is reversed by 180 degree to the opposite direction X around the pivot 12, 13. In FIG. 15 is shown reversed scissors to provide another and sharp cutting edges and/or adapted to left handed persons.

The reversible scissors may have thumb screws 12a, 13a (FIGS. 6, 7) for fastening ring members 8a, 10a to operating handles 3a, 4a respectively. It is necessary to loose thumb screws 12a, 13a for reversing the scissors to utilize the other pair of cutting edges.

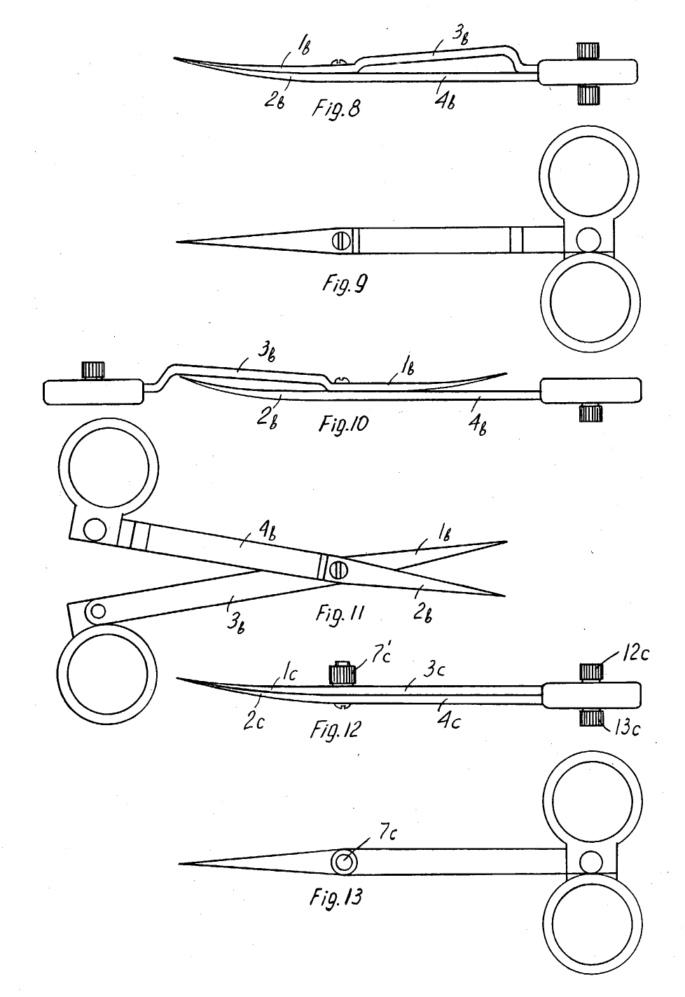

The reversible scissors may have a curved pair of two edge cutting blade members 1b, 2b (FIGS. 8, 9) with operating handles 3b, 4b which one of handles 3b is formed an arch for possibility to reverse the scissors. In FIG. 10 is shown cutting blade members 1b and 2b are disposed against handles 3b and 4b in relation for reversing. In FIG. 11 is shown the reversible scissors in reversed open position.

The reversible scissors may have a curved pair of two edge cutting blade members 1c, 2c (FIGS. 12, 13) with operating handles 3c, 4c pivotally connected by screw 7c and thumb nut 7′c. In this case, in order to reverse scissors the thumb nut 7′c must be detached from screw 12c and 13c loosened.

The reversible scissors may be with crane position of ring members concerning the cutting blade members and handles change-over to opposing and offset, and may have a two edge cutting blade member 2d with operating handle 4d pivotally connected by screw 7d and thumb nut 7′d. A ring member 8d is formed integral with the handle 3d and the ring member 10d is fastened to the handle 4d by thumb screw 13d. It is necessary to loose the thumb nut 7′d and thumb screw 13d for reversing scissors. In FIG. 16 is shown the reversible scissors in reversed close position which adapted for left handed persons, or for use sharp pair of cutting edges.

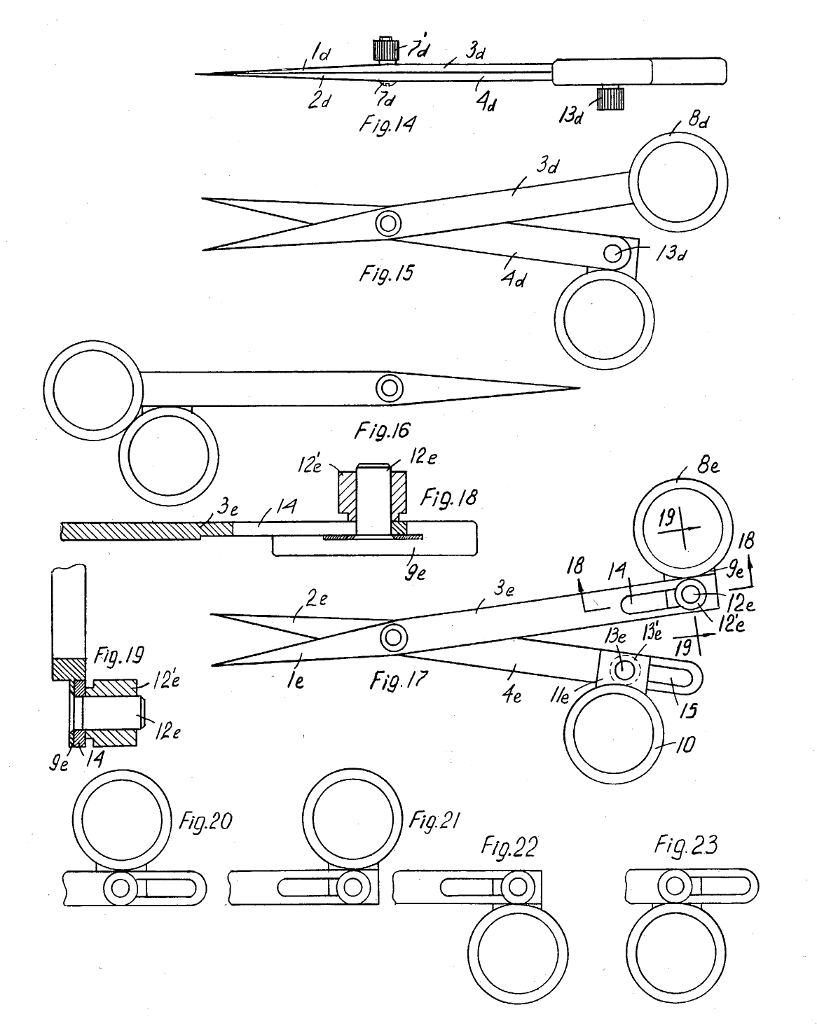

The reversible scissors may be with offset position of ring members concerning the cutting blade members and handles change-over to opposing and crane, and may have a pair of two edge cutting blade members 1e, 2e (FIGS. 17 to 19) with operating handles 3e, 4e have longitudinal slots 14, 15, and traveling ring members 8e, 10e. The screw 12 is rigidly fixed with the neck 9e of the ring member 8e and the screw 13e is rigidly fixed with the neck 11e of the ring member 10e. Traveling ring members 8e, 10e may be fastened to handles 3e, 4e by thumb nuts 12′e, 13′e in different position of longitudinal slots 14, 15, allow to use the reversible scissors into position for convenient combination of ring members: offset, opposing, or crane and adapt to right or left handed persons. In FIGS. 20 to 23 are shown different position if traveling ring member in relation to handle.

The invention is not limited to details shown since structural changes are possible without departing from the spirit of the same.

What is claimed is:

1. A reversible scissors comprising a pair of pivotally connected two edge cutting blades, operating handles and rings in which at least one of said rings is connected pivotally around a vertical axis with and movably along said handles.

2. A reversible scissors as defined in claim 1, in which said blades are curved and one of said handles is arched.

3. A reversible scissors as defined in claim 1, in which each said handle is provided with a longitudinal slot and each said ring is fastened to the handle.
